(19) United States
(12) Patent Application Publication
(10) Pub. No.: US 2006/0171155 A1
(43) Pub. Date: Aug. 3, 2006

(54) Motorcycle spotlight assembly

(76) Inventor: Ronald C. Hain, Big Rock, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 11/273,725

(22) Filed: Nov. 14, 2005

Related U.S. Application Data
(60) Provisional application No. 60/627,494, filed on Nov. 12, 2004.

(51) Int. Cl. B62J 6/00

(52) U.S. Cl. 362/473

(57) ABSTRACT

A mounting arrangement is provided for a vehicle spotlight assembly for a vehicle having a handlebar for steering. The spotlight assembly includes a tubular outer stem and a lamp rotatably mounted to a distal end of the outer stem. A handle is operatively connected to a base end of the outer stem, and at least one inner stem is fit within the outer stem. The inner stem is rotatable about an axis thereof within the outer stem, and the inner stem is operatively connected to the handle and to the lamp to selectively orient the beam direction of the lamp by moving the handle. The mounting arrangement includes a bracket head having a central channel, wherein the bracket head is mountable to the handlebar. The tubular outer stem of the spotlight assembly is fit within the central channel. A first support bracket can be connected to the bracket head and connectable to the handlebar to elevate the bracket head above the handlebar. A further support bracket can be connected to the outer stem between the lamp and the bracket head, connectable to the wind deflector of the vehicle.

This application claims the benefit of provisional application 60/627,494, filed Nov. 12, 2004.

### TECHNICAL FIELD OF THE INVENTION

The invention relates to spotlight assemblies and particularly spotlight assemblies for motorcycles.

### BACKGROUND OF THE INVENTION

Spotlights for mounting in and on law enforcement automobiles are known, such as described in U.S. Pat. Nos. 5,386,350 and 1,702,722. U.S. Pat. No. 5,386,350 depicts a Unity Manufacturing Co. brand spotlight. The UNITY brand spotlights have achieved wide industry acceptance as an automobile mounted spotlight.

One style of spotlight assembly available for mounting to a motorcycle consists of a lamp attached to a vertical stem. The opposing end of the stem contains a U-shaped bar that wraps the motorcycle's handle bar. Manually unscrewing a ball mount and rotating the lamp head adjusts this light. The present inventor has recognized that this configuration suffers the drawbacks that it does not provide the motorcycle officer with an easily controllable beam direction, and is mounted at an ineffective position on the motorcycle.

Prior UNITY brand spotlights utilize an on/off toggle switch located on an end of the handle. The present inventor has recognized the advantage of incorporating a momentary on/off push button switch function into a vehicle spotlight wherein the spotlight can be used quickly and intermittently without the necessity of engaging a toggle switch into a latched on position.

Cold temperatures, combined with moisture, can impact the effectives of vehicle mounted spotlights. Problems with spotlight operation can be experienced as a result of weather conditions. More specifically, in colder temperatures, the exterior gear housing becomes frozen, rendering the spotlight ineffective.

The present inventor has recognized the advantages of providing a spotlight that was effectively operable in cold and/or wet and freezing conditions.

### SUMMARY OF THE INVENTION

The present invention provides a spotlight assembly for a motorcycle, other vehicles and devices. The present invention provides an improved mounting arrangement for mounting a spotlight.

The invention provides a mounting arrangement for a vehicle spotlight assembly for a vehicle having a handlebar for steering, wherein the spotlight assembly includes a tubular outer stem and a lamp rotatably mounted to a distal end of the outer stem. The lamp has a beam direction. A handle is operatively connected to a base end of the outer stem, and at least one inner stem is fit within the outer stem. The inner stem is rotatable about an axis thereof within the outer stem, and the at least one inner stem is operatively connected to the handle and to the lamp to selectively orient the beam direction of the lamp by moving the handle. The mounting arrangement includes a bracket head having a central channel, wherein the bracket head is mountable to the handlebar. The tubular outer stem of the spotlight assembly is fit within the central channel.

Advantageously, the mounting arrangement includes a first support bracket, the support bracket connected to the bracket head and connectable to the handlebar to elevate the bracket head above the handlebar. When the vehicle includes a wind deflector that turns with the handlebar, the mounting arrangement can include a further support bracket connected to the outer stem between the lamp and the bracket head, connectable to the wind deflector.

The invention provides a vehicle spotlight assembly for a vehicle having a handlebar for steering. The assembly includes a bracket head, a tubular outer stem, a lamp, a handle and a tubular inner stem. The bracket head has a central channel. The bracket head is mountable to the handlebar. The tubular outer stem fits within the central channel. The lamp is rotatably mounted to a distal end of the outer stem. The lamp has a beam direction. The handle is operatively connected to a base end of the outer stem. The at least one inner stem fits within the outer stem. The inner stem is rotatable about an axis thereof within the outer stem. The at least one inner stem is operatively connected to the handle and to the lamp to selectively orient the beam direction of the lamp by moving the handle.

A support bracket can be connected to the bracket head and can be connected to the handlebar to elevate the bracket head above the handlebar.

When the vehicle includes a wind deflector that turns with the handlebar, a further support bracket can be connected to the outer stem between the lamp and the bracket head and connected to the wind deflector. The further support bracket is advantageously located at a distance from the first support bracket wherein the combination of the first and further support brackets provides increased rigidity to stabilize the spotlight on the vehicle.

The spotlight assembly of the present invention provides the advantages of the UNITY brand adjustable spotlight, or the like, to the motorcycle officer. The spotlight assembly of the present invention provides a motorcycle mounted spotlight with 360 degrees of adjustable lighting operated by a handle with a 1:1 ratio to the lamp. The assembly places the lamp in front of the wind deflector or fairing of the motorcycle for an effective positioning of the lamp.

The invention provides bracket assemblies that can mount a UNITY brand or similar spotlight having a lamp attached to an elongated stem in a substantially horizontal plane. The bracket assemblies can comprise one bracket head and an attachment assembly. The bracket head can be a universal part while the attachment assemblies can be model-specific. For example, one attachment assembly affixes to the HARLEY DAVIDSON ELECTRA GLIDE model motorcycle and the other attachment assembly affixes to the HARLEY-DAVIDSON ROAD KING model motorcycle.

One exemplary cross-sectional shape of the bracket head has a semi-circular side and a rectangular side. The bracket head contains a one-half inch bore from end to end. This bore is configured to clamp or otherwise fix the stem of the spotlight therein. Accordingly, the bracket head can be cut or split on a forty-five degree angle from the bore to the exterior of the unit forming a gap. This gap allows the bore to act as a clamp around the spotlight stem. Two compression screws compress the gap. Three holes are drilled and tapped into the side of the bracket head to facilitate the application of the attachment assemblies. An alternate embodiment eliminates the gap and instead provides a set screw for fixing the stem within the central bore.

One embodiment attachment assembly for the ELECTRA GLIDE model motorcycle comprises a U-shaped bracket that attaches to the side of the bracket head. One arm of the U-shaped bracket is bent to facilitate the curve of the front fairing of the vehicle. The far end of this arm contains a single drilled hole for attachment to the fairing using an existing vehicle screw. The opposing arm contains two drilled and tapped compression screw holes for engaging compression screws. The ends of the screws are fitted with rubber end caps. These compression screws position and support the bracket when attached to the vehicle.

One embodiment attachment assembly for the ROAD KING model motorcycle comprises two pieces. One piece is Z-shaped and attaches to the windshield. This attachment has a “U-shaped” lip or hook on the inside of the Z-shape. The upper portion of the “Z” contains a one-half inch hole or slot to hold the lamp end of the stem of the spotlight. The lower portion contains a one-quarter inch hole for attachment to the windshield mount using an existing vehicle screw.

A second attachment piece for the ROAD KING model motorcycle is a U-shaped bracket that affixes to the bottom of the universal bracket head and holds the bracket head to the motorcycle's handle bar.

Another embodiment for the ELECTRA GLIDE model includes an approximately “]” shaped first bracket that clamps to the motorcycle handlebar and is fastened to the universal bracket head. A further bracket fastens to the winds screen and includes a hole for journaling or restraining movement of the spotlight stem at a distance from the bracket head.

An improved operating switch for a vehicle spotlight is provided by the invention. This switch can be incorporated into spotlights that are mounted to motorcycles, automobiles, or any type of vehicle or mobile equipment.

The switch of the present invention comprises a push button switch and surrounding switch housing to replace the currently used toggle and toggle switch housing. The push button switch housing mounts directly onto the handle using the existing machine screw mounts on the handle. The push button is located on the end of the handle switch housing. The push button is oval shaped. The push button is attached to a switch mounted inside the switch housing. When the push button is depressed, the switch head is pushed in causing a positively charged line affixed to the end of the switch to make contact with the positive line located inside the spotlight stem.

The push button switch of the invention has three positions: latched-on, off, and momentary on. The off position places the push button in full outward extension. The latched-on position places the push button in a depressed position. Momentary on operation occurs when the user depresses the push button to a point between off and latched-on, and causes the light to activate only by finger pressure. This design does not allow the push button to be depressed below the exterior of the end of the switch housing during the on, off, or momentary position due to crash test safety concerns, i.e., the rounded switch button head is always at least slightly protruding.

The invention also provides for an effective, compact design of the lamp, particularly useful for a motorcycle application, but also useful for other vehicles and applications. The field and strength of illumination should not be compromised as a result of a size reduction of the lamp. In order to compensate for the reduction in size, an MR-11, 35-watt halogen bulb can be used that is approximately one-quarter the size of the current bulb used in UNITY brand spotlights. When backed by an etched, concave reflector it creates similar illumination to the current lamp.

As an alternate embodiment, one or more light emitting diode (LED) lamps can be used. LEDs are high output and extremely durable, with most models offering 100,000 hours of continuous use. Inverting the LED bulb so that it faces the mirrored reflector results in greater broadcast of the light.

According to another aspect of the invention, a heat source is added to the spotlight assembly to prevent freezing of the spotlight. This improvement is particularly useful for automobile applications but could be useful for other vehicles and applications. Products such as heating tape and coil will maintain a constant temperature and can be inserted within the housing. The target constant temperature for the heating element is between 50 to 70 degrees; this will ensure fluid operation in all climates. The heating element can use the DC current already connected to the spotlight as its power source. Advantageously, a constant temperature for the unit is maintained, thereby avoiding freezing and the resulting malfunction of spotlights in cold weather use. The compact size of these heating elements allow for easy insertion and space conservation.

According to another aspect of the invention, the spotlight improvements can be applied to motorcycles, snowmobiles, three or four-wheelers such as all terrain vehicles, and bicycles. In the case of vehicles operated with batteries, such as motorcycles and four wheelers, a simple bracket installation and power connection would allow the use of the shortened spotlight with these vehicles.

For bicycles, a rechargeable battery pack connected to a spotlight bracketed to the handlebars would be an extremely useful addition. The spotlight assembly could also be installed on ballistic shields used by S.W.A.T. teams.

Numerous other advantages and features of the present invention will become readily apparent from the following detailed description of the invention and the embodiments thereof, and from the accompanying drawings.

### BRIEF DESCRIPTION OF THE DRAWINGS

FIG. 1 is a fragmentary front perspective view of a motorcycle with the spotlight assembly of the present invention;

FIG. 2 is a fragmentary rear perspective view of the motorcycle of FIG. 1;

FIG. 3 is a bottom perspective view of a bracket head of the spotlight assembly of FIG. 1;

FIG. 4 is a side perspective view of the bracket head of FIG. 3;

FIGS. 5 though 8 are perspective views of a spotlight attachment assembly taken from FIG. 1;

FIGS. 9 and 10 are perspective views of a bracket assembly taken from FIG. 5;

FIG. 11 is a top view of the bracket head of FIGS. 3 and 4;

FIG. 12 is an end view of the bracket head of FIG. 11;

FIG. 13 is a bottom view of the bracket head of FIG. 12;

FIG. 14 is a front view of the bracket assembly of FIGS. 9 and 10;

FIG. 15 is a top view of the bracket assembly of FIG. 14;

FIG. 16 is a left side view of the bracket assembly of FIG. 15;

FIG. 17 is a side, fragmentary perspective view of a motorcycle with an alternate embodiment spotlight assembly of the invention;

FIG. 18 is an enlarged fragmentary perspective view taken from FIG. 17;

FIG. 19 is a fragmentary perspective view taken from FIG. 17;

FIG. 20 is an enlarged, fragmentary perspective view taken from FIG. 19;

FIG. 21 is a front fragmentary perspective view of the motorcycle and alternate embodiment spotlight assembly of FIG. 17;

FIG. 22 is a front view of a portion of a bracket assembly taken from FIG. 17;

FIG. 22A is a front view of an alternate embodiment of the bracket assembly shown in FIG. 22;

FIG. 23 is a top view of the bracket assembly of FIG. 22;

FIG. 24 is a right side view of the bracket assembly of FIG. 22;

FIG. 25 is a side view of U-bolt used in a second portion of the bracket assembly;

FIG. 26 is a top view of the U-bolt of FIG. 25;

FIG. 27 is a fragmentary, perspective view of a spotlight assembly mounted to a vehicle and having a switch assembly of the present invention;

FIG. 28 is an enlarged perspective view of the spotlight assembly of FIG. 27;

FIG. 29 is an enlarged front view of the switch assembly shown in FIG. 28;

FIG. 30 is a side view of the switch assembly of FIG. 28 with surrounding portions removed for clarity;

FIG. 31 is a right side view of the switch assembly of FIG. 30;

FIG. 32 is an exploded view of the switch assembly of FIG. 30;

FIG. 33 is a schematic diagram of a further embodiment of the invention;

FIG. 34 is a bottom perspective view of an alternate embodiment bracket head;

FIG. 35 is a left side view of the alternate embodiment bracket head shown in FIG. 34;

FIG. 36 is a fragmentary perspective view of an alternate embodiment spotlight mounting arrangement to that shown in FIG. 2;

FIG. 37 is a front view of a first support bracket shown in FIG. 36;

FIG. 38 is a view taken generally along line 38-38 of FIG. 37;

FIG. 39 is a fragment three perspective view of a further support bracket shown in FIG. 36; and

FIG. 40 is a front perspective view of the mounting arrangement shown in FIG. 36.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

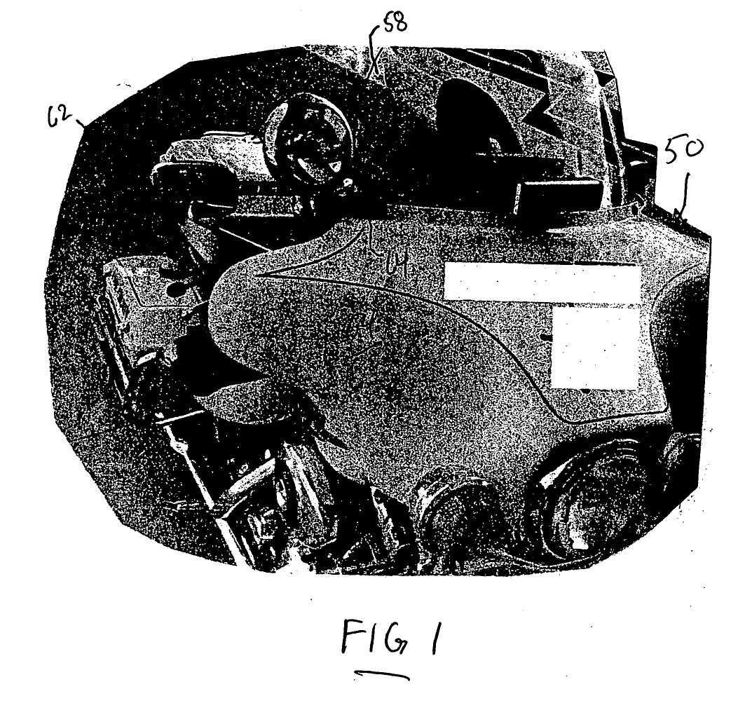

FIG. 1 illustrates a motorcycle 50 having a fairing or wind deflector 54 that mounts a transparent windscreen 58. A spotlight assembly 62 is mounted to the fairing 54. The spotlight is of the type described in U.S. Pat. Nos. 5,386,350 and 1,702,722, herein incorporated by reference, or commercially available from Unity Manufacturing Company of Chicago, Ill., USA. A screw 64 that is used to mount the windscreen 58 to the fairing 54 is used to mount the spotlight assembly 62.

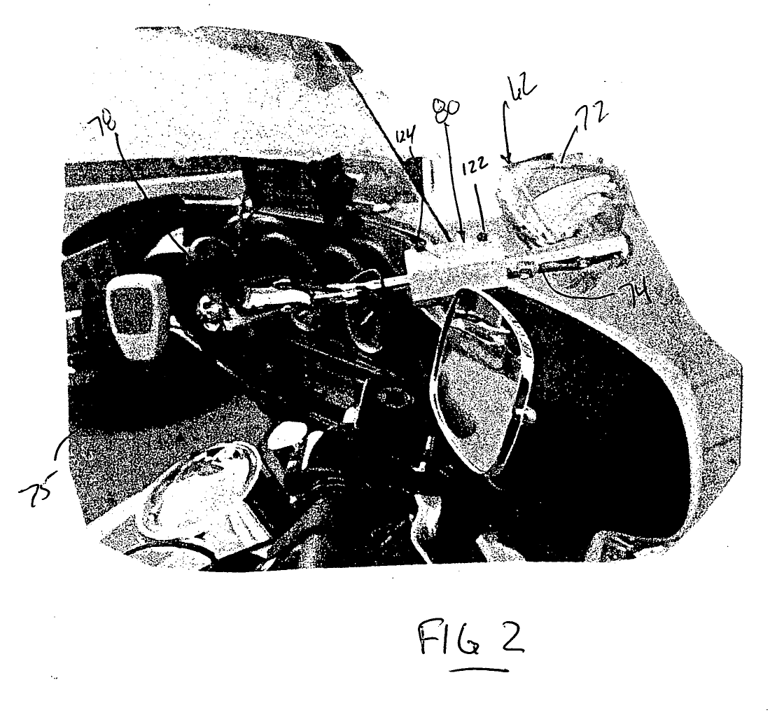

As shown in FIG. 2 the spotlight assembly 62 includes a lamp 72 mounted to a lamp support 74. A tubular outer stem 77 extends axially between the lamp support 74 and the end portion 75. A handle 78 extends at an angle from a base end portion 75. As described more completely in U.S. Pat. No. 1,702,722, rotation of the handle 78 about the axis of the outer stem 77 and rotation of the handle 78 about its axis allow for precise aiming of the lamp 72 over a wide field. To accomplish this, within the outer stem 77 is a hollow rockshaft and a lamp rotating shaft, within the hollow rockshaft, and corresponding gears.

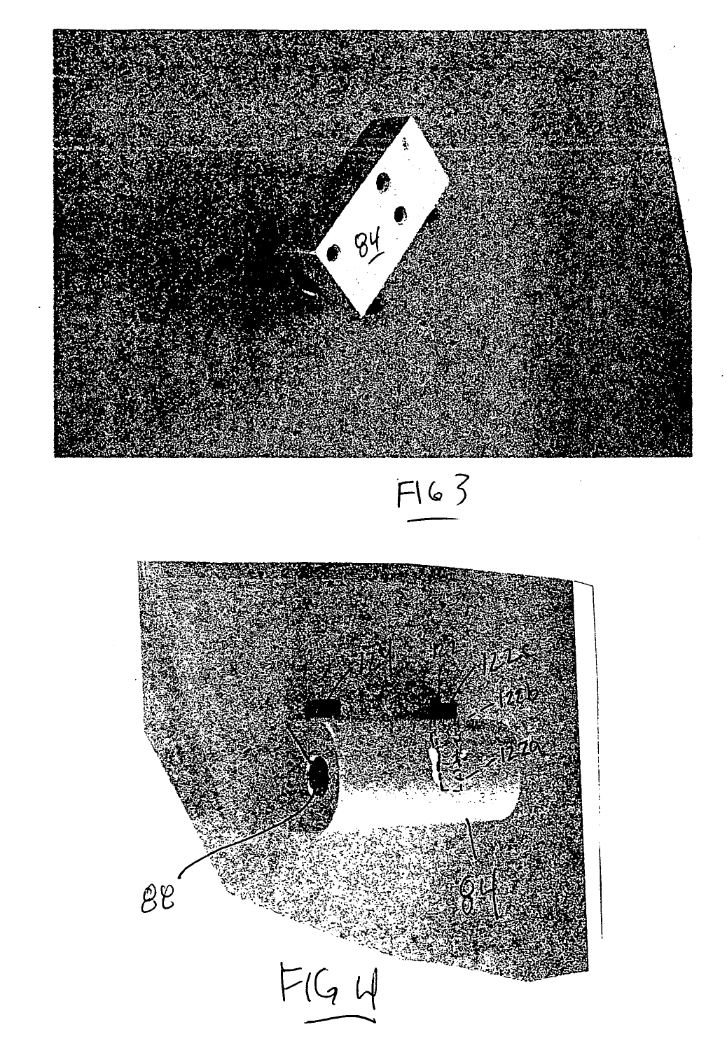

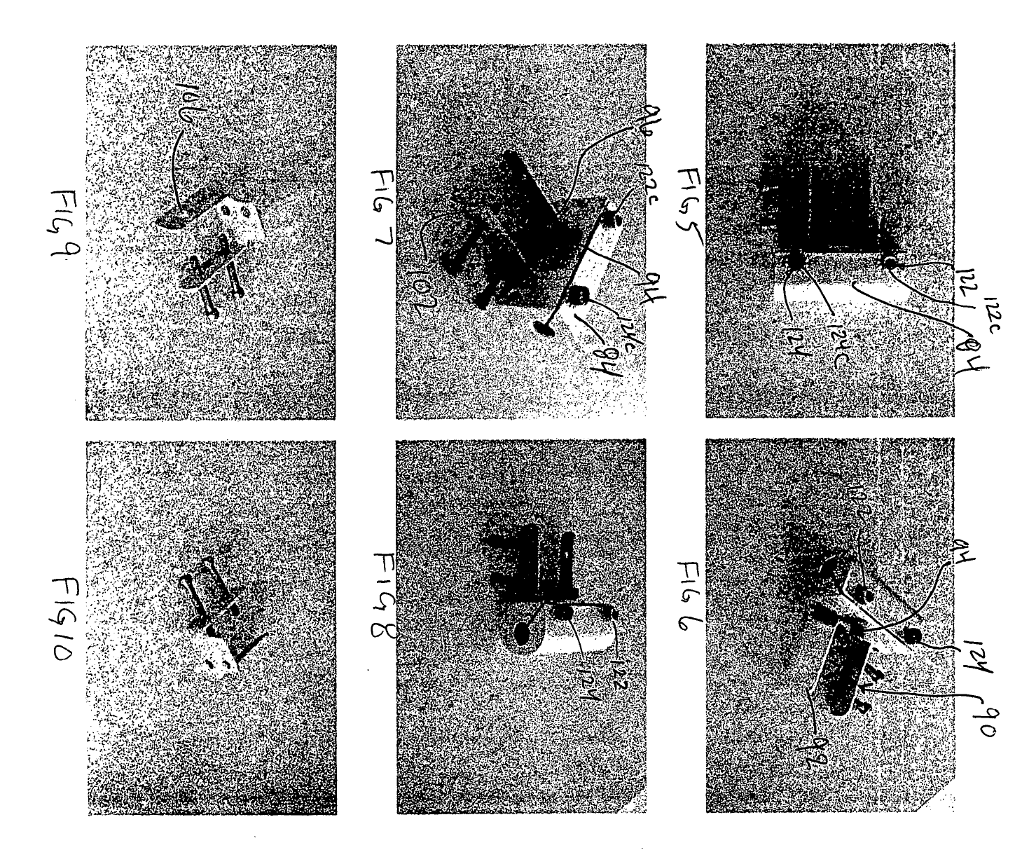

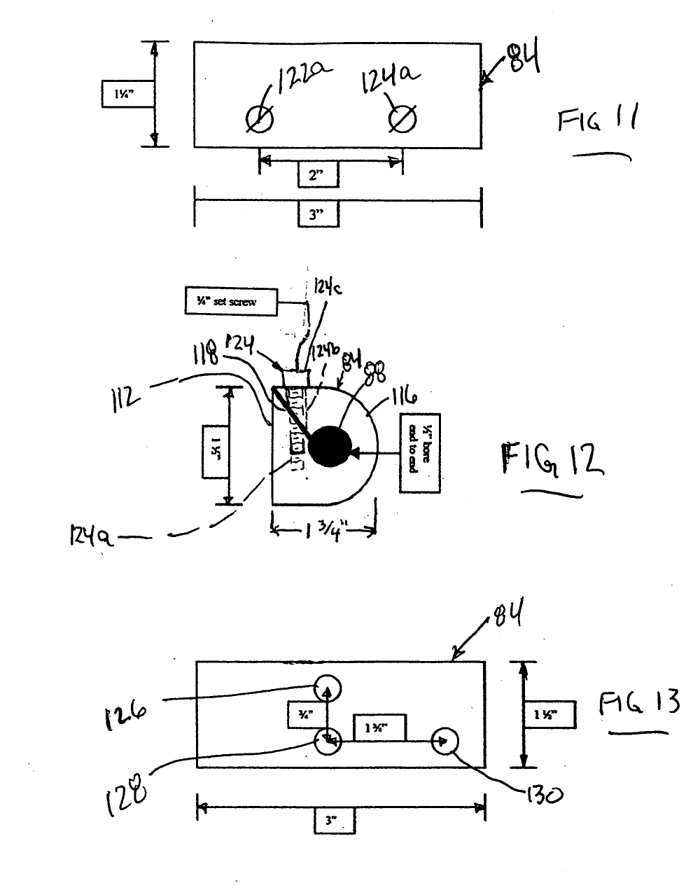

The stem 77 is fixed within an attachment assembly 80. The assembly 80 includes a bracket head 84 shown in FIGS. 3-8 and 11-13.

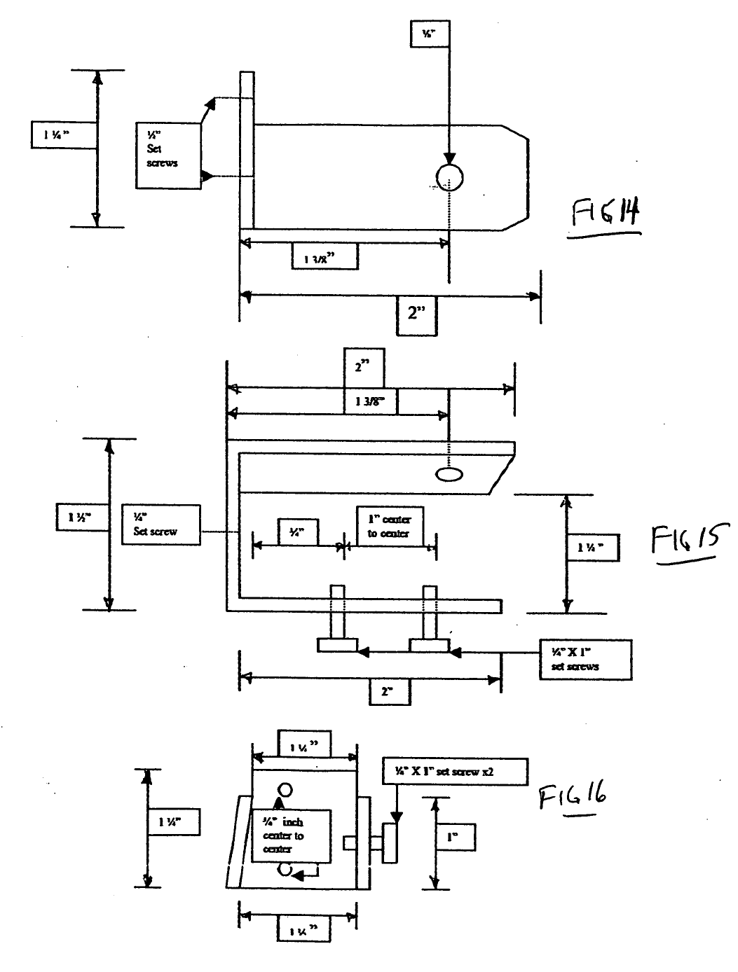

The bracket head 84 includes a central bore 88. The central bore 88 receives and clamps the stem 77. A bracket assembly 90 (FIGS. 1, 5-10, 14-16) is fastened to the side of the bracket head 84. The assembly 90 includes a U-shaped bracket 92 and fasteners 94, 96, 98, 100. Two fasteners 94, 96 fasten the U-shaped bracket to the bracket head 84. Two additional fasteners 98, 100 are threaded into tapped holes provided in a back leg 102 of the U-shaped bracket 92. A front leg 104 provides a hole 106 for receipt of the fairing screw 64 shown in FIG. 1. The two legs 102, 104 straddle the fairing 54. The front leg 104 is secured to the fairing 547 with the screw 64. The back leg 102 is braced against the fairing by threading the fasteners 98, 100 in the leg 102 until the ends of the fasteners 98, 100 press against a back face of the fairing 54. Thus the bracket 90 will be fastened and clamped to the fairing 54. The fasteners 98, 100 are provided with rubber caps so as not to damage the backside of the fairing 54.

FIGS. 11-13 show the bracket head 84 in more detail. The head 84 has a flat side 112 and a rounded side 116. The bore 88 extends axially through the head 84. A slot 118 is cut through a portion of the head intersecting an outside of the head 84 and the central bore 88. Two cap screws 122, 124 are fit through plain bores 122b, 124b of the head 84; the plain bores 122b, 124b located between the heads 122c, 124c of the cap screws and the slot 118. The cap screws 122, 124, extend across the slot 118, and are threaded into threaded bores 122a, 124a of the head 84 that begin at the slot 118 and extend to a depth into the head greater than the expected penetration of the cap screws. Tightening the cap screw heads 122c, 124c against the head 84 diminishes the width of the slot 118 and clamps the head 84 to a desired tightness around the stem 77.

The bottom of the head 84 includes threaded holes 126, 128, 130. The holes 126, 128 are used to attach the U-shaped bracket 90. The hole 130 is not used for this embodiment.

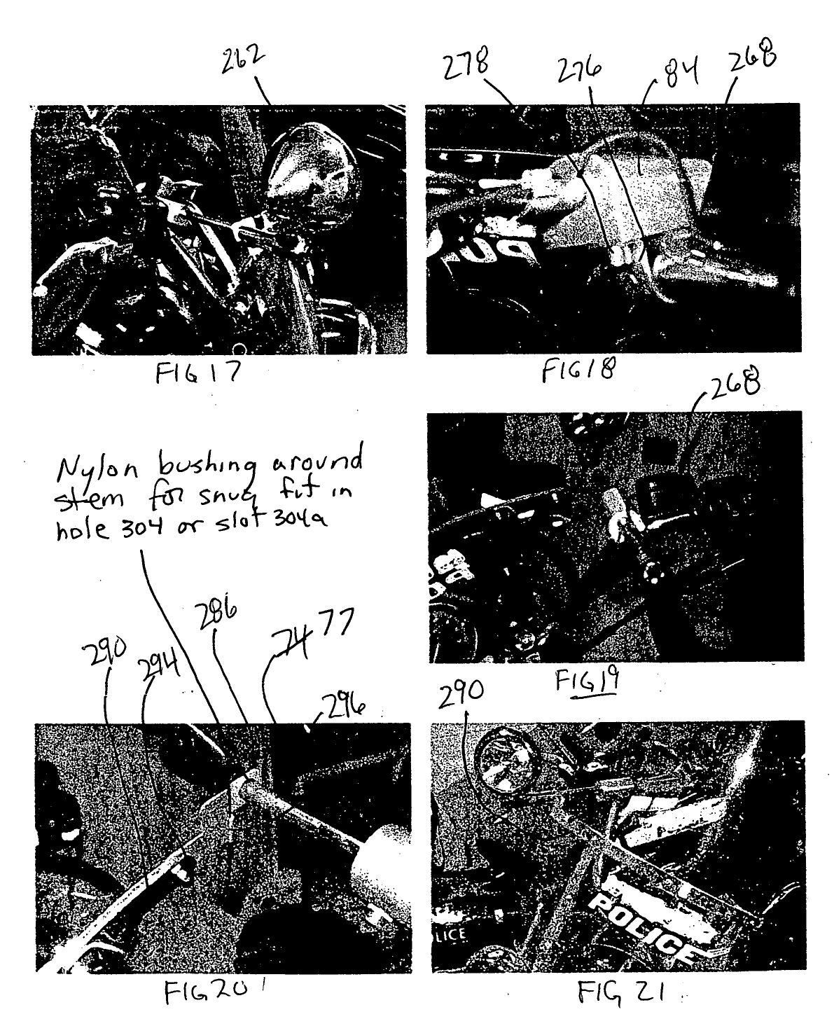

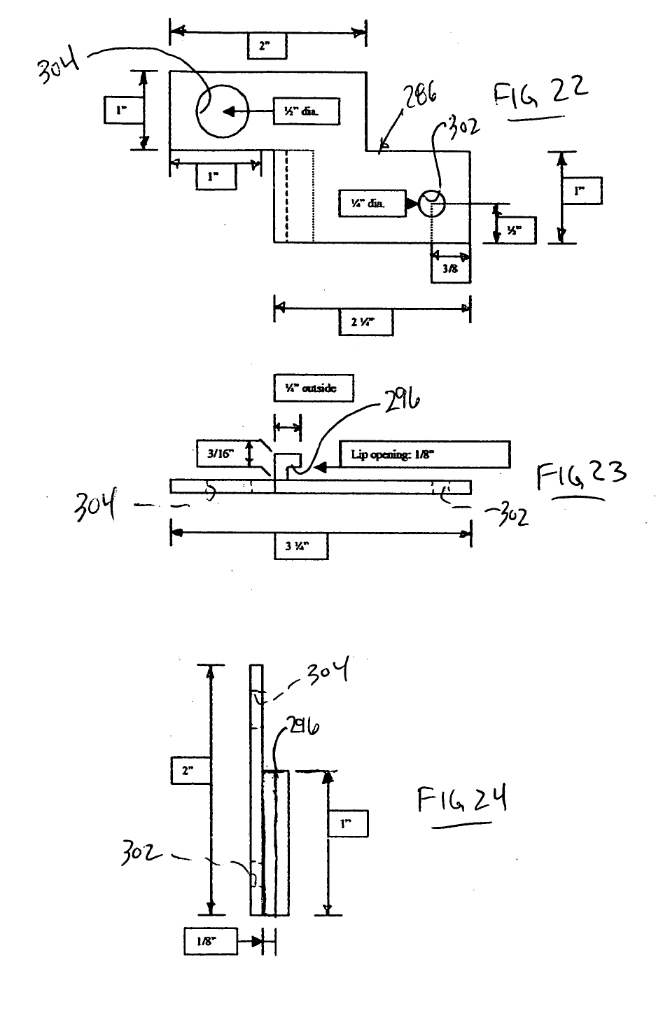

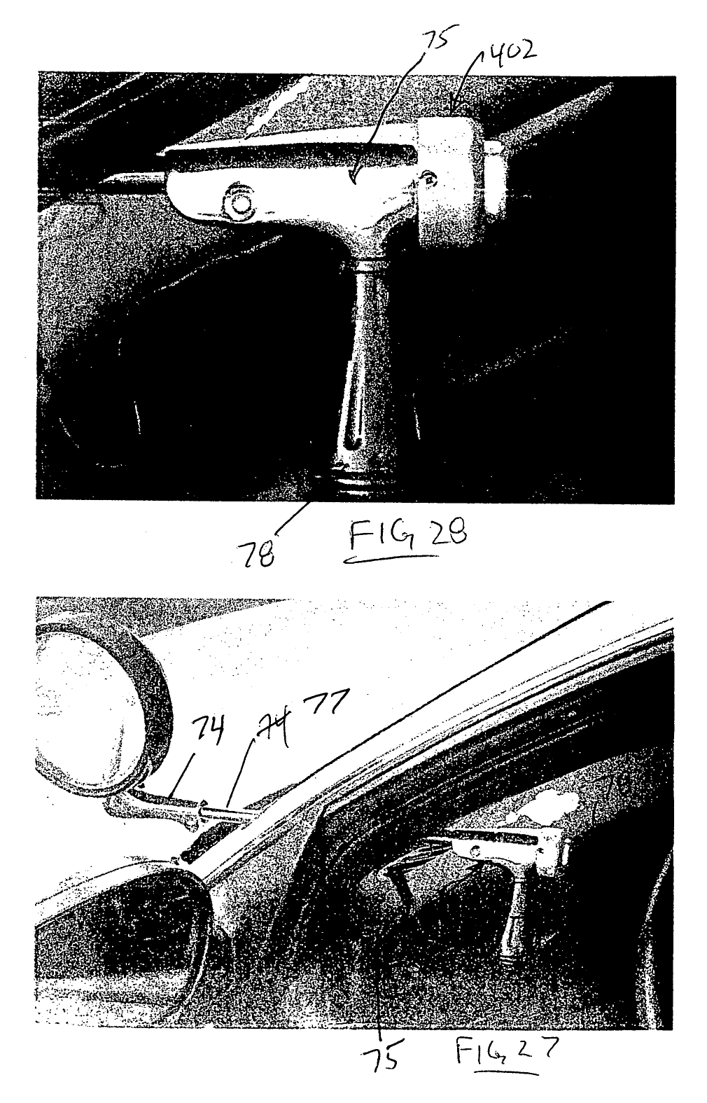

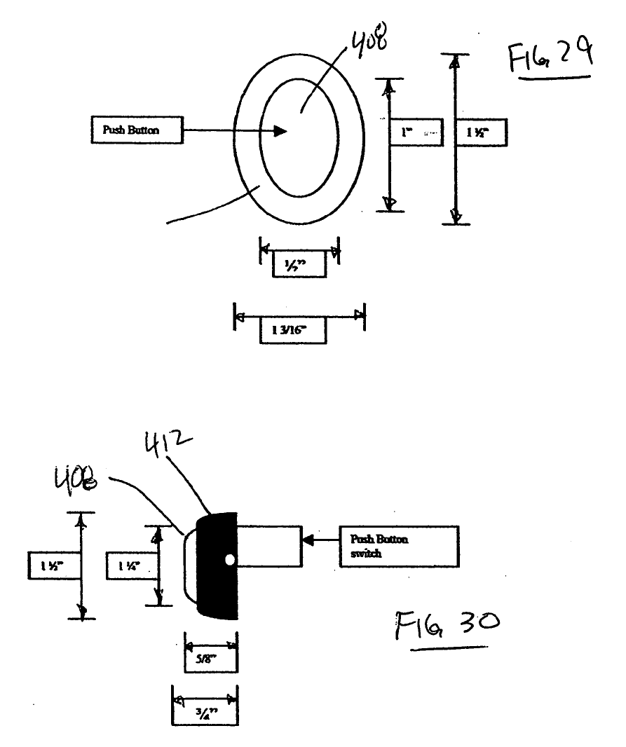

FIGS. 17-26 illustrate an alternate embodiment spotlight assembly 262. An alternate attachment assembly 90 is used. According to this assembly 264, the bracket head 84 is attached to the motorcycle handlebar 268 using a U-shaped bracket 276 and two cap screws 278, 280. The stem 74 is supported in front of the head 84 by a bracket 286 that is fastened to a lateral support 290 of the windscreen by use of existing screw 294 and a lip or hook 296 formed on the bracket 286. The bracket 286 provides a hole 302 for penetration by the screw 294 and a hole 304 for penetration by the stem 74.

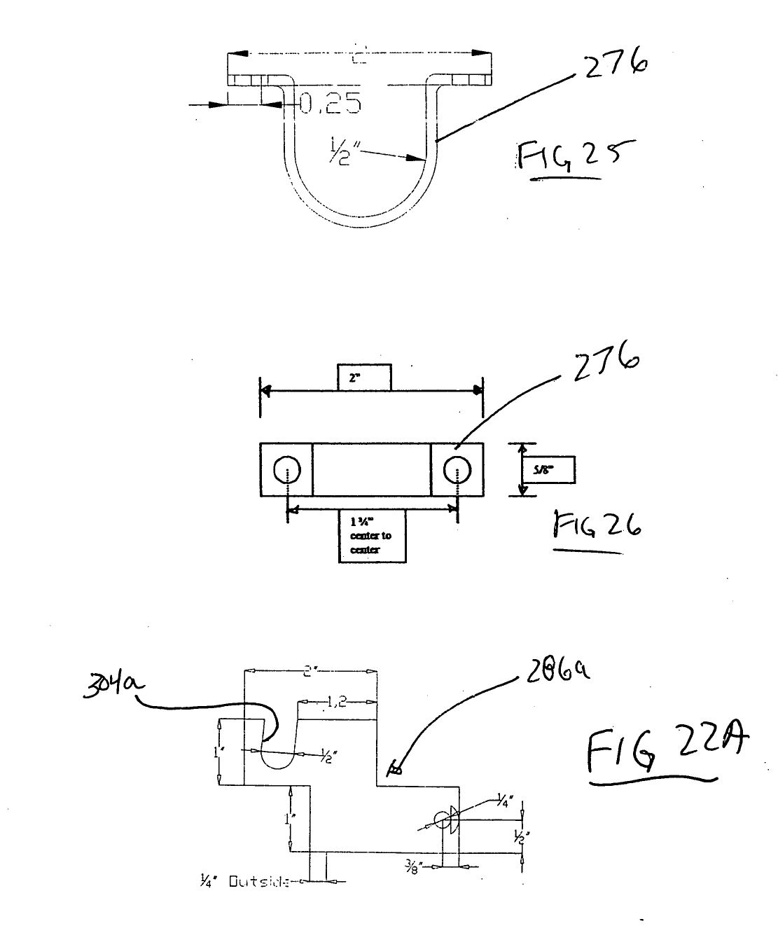

According to a refinement of the arrangement of FIGS. 17-26, the bracket 286 of FIG. 22 is replaced with the bracket 286a shown in FIG. 22A. This bracket 286a is identical to the bracket 286 except that the hole 304 is replaced by a slot 304a. Additionally, only the cap screw 278 (closest to the driver) is used to secure the U-shaped bracket 276. Slots 304a and the missing cap screw allow for the spotlight assembly to break away from the handlebar and fairing 54 during a collision, while still providing a sufficiently rigid spotlight mounting.

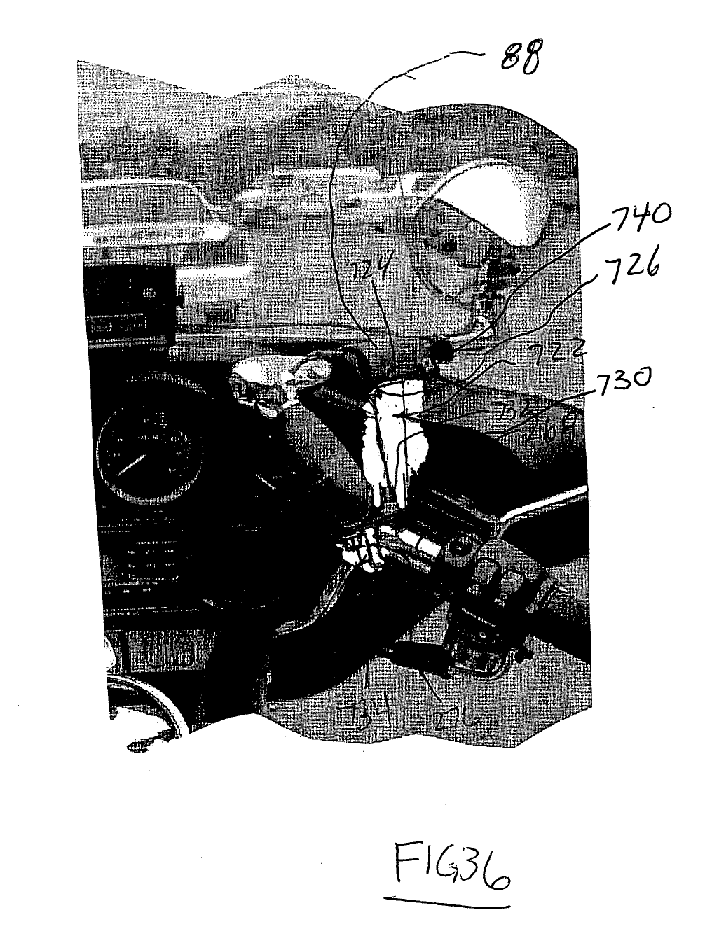

FIG. 34 illustrates an alternate bracket head 702. Unlike the bracket head 84 shown in FIGS. 3-4 and 12, the bracket head 702 does not have a slot 118. Instead of clamping, a threaded bore 706 is provided that intersects the central channel or bore 88. The bore 706 receives a set screw that threadingly locks against the stem 77 that is fit through the bore 88.

FIG. 35 illustrates two threaded attachment bores 712, 714 used to fasten the bracket head 702 to either the U-shaped bracket 276 or to a vertical bracket as described below.

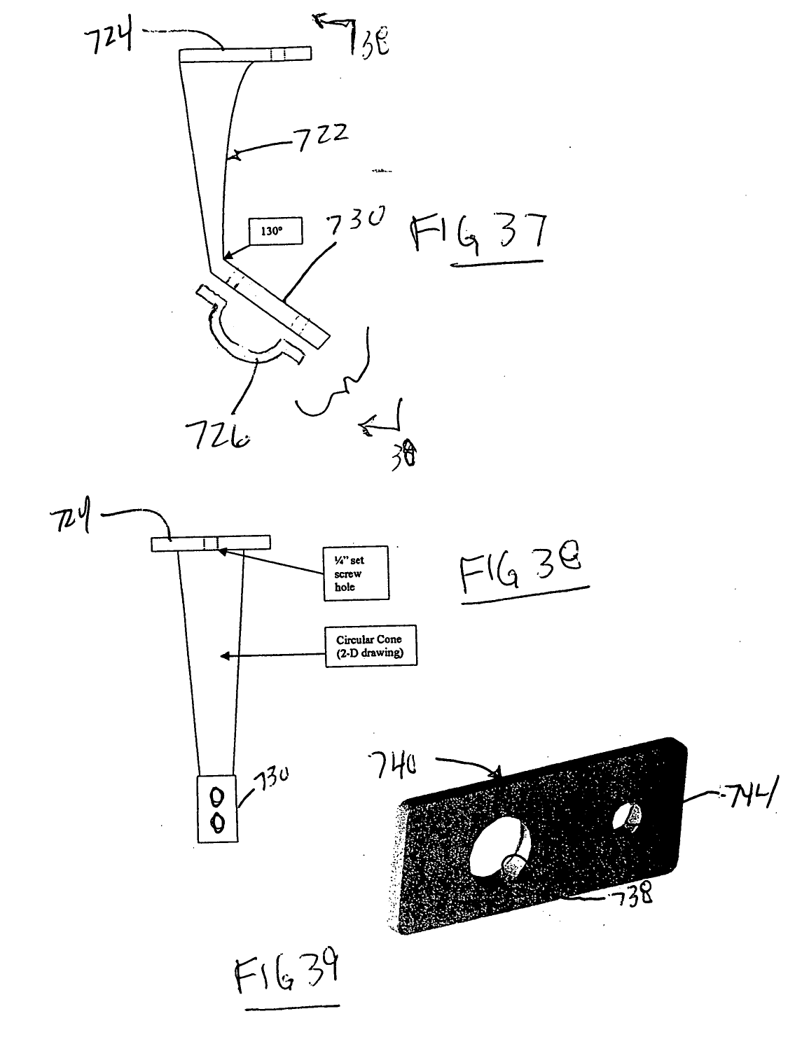

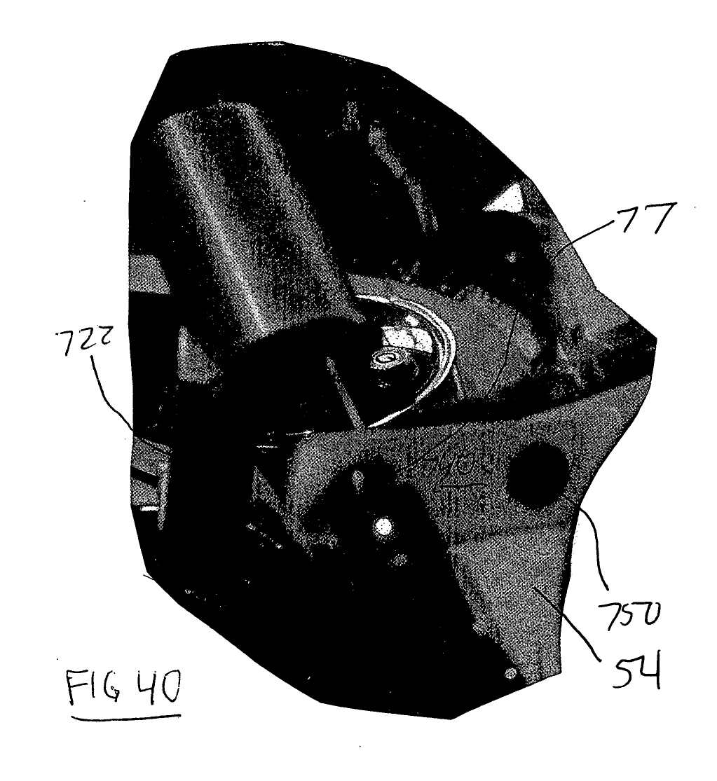

FIG. 36 illustrates an alternate mounting arrangement. An approximately “]” or channel shaped bracket 722 is fastened to the bracket head 88 (or 702) through a top flange 724, using one or two fasteners 726. A bottom flange 730 is clamped to the handlebar using the U-shaped bracket 276 and two fasteners 732, 734.

Outside the bracket head 88, the stem 77 is restrained by being inserted through a hole 738 through a further bracket 740 (FIGS. 39 and 40). The further bracket 740 is fastened to the fairing 54 via a mounting hole 744 using an existing fairing screw 750 (FIG. 40). The bracket hole 738 can have an angled cut wherein both the outside surfaces of the hole have a greater diameter than a mid depth of the hole.

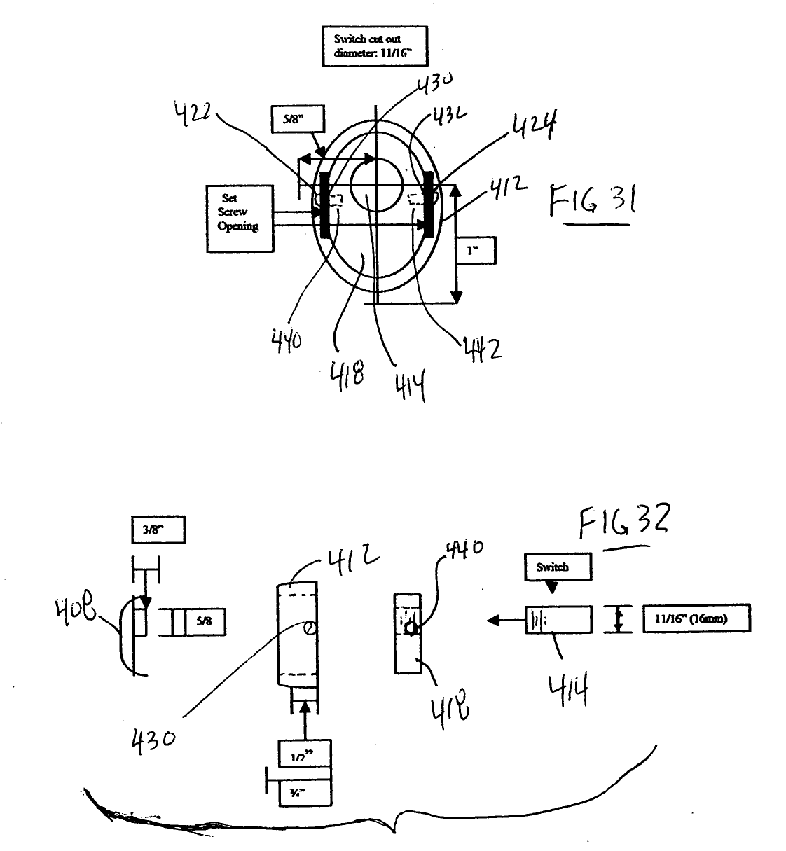

FIGS. 28-32 illustrate a further aspect of the invention. A switch assembly 402 is mounted to the base end portion 75 adjacent to the handle 78. The improved switch is designed for use with the spotlight produced by Unity Manufacturing Co., as shown in U.S. Pat. No. 5,386,350, herein incorporated by reference or as commercially available as a UNITY model 94003, 250 Series 5″ Halogen spotlight. The switch assembly 402 includes a push button actuation 408 surrounded by a housing 412. A cylindrical switch 414 is threaded into a threaded bore 417 of a holder 418 that is fixed into the housing 412. Opposite side set screws 422, 424 hold the assembly together and to the handle housing 78a.

The set screws penetrate through holes 430, 432 through the housing 412 and are threaded into tapped holes 440, 442 in the holder.

Preferably the switch is a commercially available TELEMECANIQUE 16 mm push button switch, model no. ZB6AW9.

The switch has three modes—off, momentary on, and latched on, depending on the degree of depression of the button 408.

FIGS. 11-16, 22-26, and 29-32 include some dimensions for illustrative purposes only.

As another aspect of an exemplary embodiment of the invention, an effective, compact design of the lamp can be used, particularly useful for a motorcycle application. In order to compensate for the reduction in size, an MR-11, 35-watt halogen bulb can be used that is approximately one-quarter the size of the current bulb used in UNITY brand spotlights. When backed by an etched, concave reflector it creates similar illumination to the current lamp. The lamp has a diameter of about 4.3 inches and a depth of about 3.25 inches.

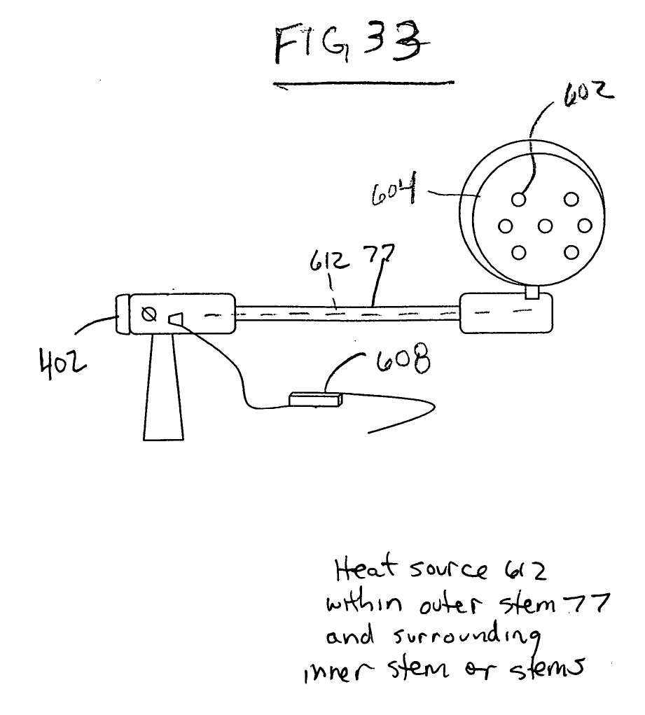

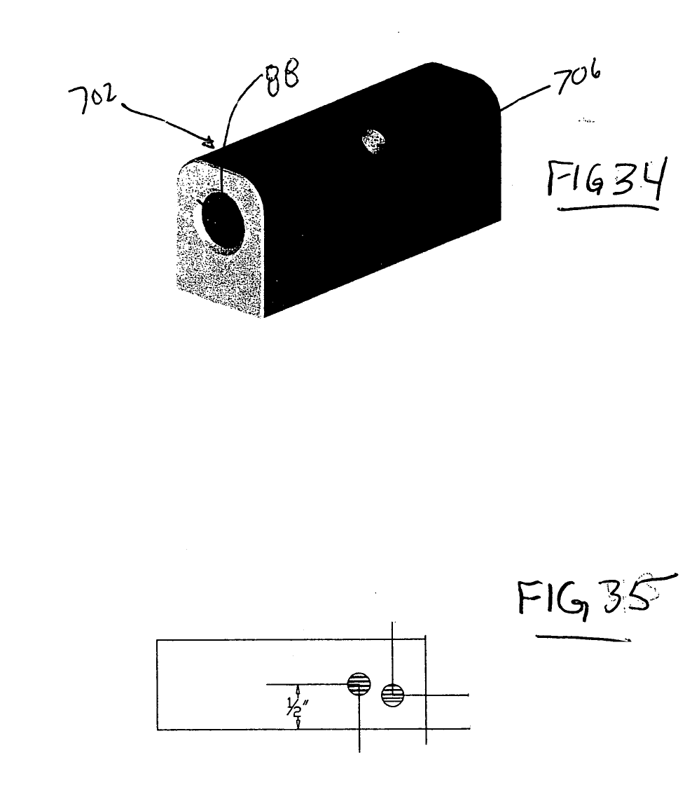

An alternate embodiment of the invention is shown schematically in FIG. 33. One or more light emitting diode bulbs (LED) 602 can be used. In the illustrated embodiment seven diode bulbs 602 are used. Each LED bulb is 3 watts corresponding to 30 lumens each. LED bulbs are high output and extremely durable, with most models offering 100,000 hours of continuous use. Inverting the LED bulbs so that they face the mirrored reflector 604 results in greater broadcast of the light. The result is a compact lamp being about 4.3 inches in diameter and about 2 inches in depth. An in-line 1000 mA SMART DRIVER 608 is also used.

According to another aspect of the invention, a heat source 612 is added to the spotlight assembly to prevent freezing of the spotlight. Products such as heating tape and coil will maintain a constant temperature and can be inserted within the housing. The target constant temperature for the heating element is between 50 to 70 degrees; this will ensure fluid operation in all climates. The heating element can use the DC current already connected to the spotlight as its power source. Advantageously, a constant temperature for the unit is maintained, thereby avoiding freezing and the resulting malfunction of spotlights in cold weather use. The compact size of these heating elements allow for easy insertion and space conservation.

According to another aspect of the invention, the spotlight and mounting improvements of the invention can be applied to motorcycles, snowmobiles, four-wheelers, and bicycles. In the case of vehicles operated with batteries, such as motorcycles and four wheelers, a simple bracket installation and power connection would allow the use of the shortened spotlight with these vehicles.

For bicycles, a rechargeable battery pack connected to a spotlight bracketed to the handlebars would be an extremely useful addition. The spotlight assembly could also be installed on ballistic shields used by S.W.A.T. teams.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A vehicle spotlight assembly for a vehicle having a handlebar for steering, comprising:
a bracket head having a central channel, said bracket head mountable to said handlebar;
a tubular outer stem fit within said central channel;
a lamp rotatably mounted to a distal end of said outer stem, said lamp having a beam direction;
a handle operatively connected to a base end of said outer stem; and
at least one inner stem fit within said outer stem, said inner stem rotatable about an axis thereof within said outer stem, said at least one inner stem operatively connected to said handle and to said lamp to selectively orient said beam direction of said lamp by moving said handle.

2. The spotlight assembly according to claim 1, comprising a first support bracket, said support bracket connected to said bracket head and connectable to said handlebar to elevate said bracket head above said handlebar.

3. The spotlight assembly according to claim 1, wherein said vehicle includes a wind deflector that turns with said handlebar, and further comprising a further support bracket connected to said outer stem between said lamp and said bracket head and connectable to said wind deflector.

4. The spotlight assembly according to claim 1, comprising a switch for selectively providing electrical power to said lamp, said switch including a pushbutton actuator having three modes of operation: off, momentary on, and latched on, said switch mounted to said handle.

5. The spotlight assembly according to claim 1, wherein said lamp comprises a plurality of light emitting diodes.

6. The spotlight assembly according to claim 1, wherein said lamp comprises a halogen bulb.

7. The spotlight assembly according to claim 1, wherein said vehicle comprises a motorcycle.

8. The spotlight assembly according to claim 1, wherein said vehicle comprises a snowmobile.

9. The spotlight assembly according to claim 1, wherein said vehicle comprises a bicycle.

10. The spotlight assembly according to claim 1, wherein said vehicle comprises a three or four wheel all-terrain vehicle.

11. in a spotlight assembly for a vehicle that includes a tubular outer stem, a lamp rotatably mounted to a distal end of said outer stem, said lamp having a beam direction, a handle operatively connected to a base end of said outer stem, and at least one inner stem fit within said outer stem, said inner stem rotatable about an axis thereof within said outer stem, said at least one inner stem operatively connected to said handle and to said lamp to selectively orient said beam direction of said lamp by moving said handle, wherein said lamp and at least a portion of said outer stem are located outside of the vehicle and said handle is located within said vehicle, the improvement comprising:
a heat source applied to at least one of said lamp and said portion of said outer stem.

12. The improvement according to claim 11, wherein said heat source is located within said outer stem.

13. A mounting arrangement for vehicle spotlight assembly for a vehicle having a handlebar for steering, wherein the spotlight assembly includes a tubular outer stem, a lamp rotatably mounted to a distal end of said outer stem, said lamp having a beam direction, a handle operatively connected to a base end of said outer stem, and at least one inner stem fit within said outer stem, said inner stem rotatable about an axis thereof within said outer stem, said at least one inner stem operatively connected to said handle and to said lamp to selectively orient said beam direction of said lamp by moving said handle, comprising:
a bracket head having a central channel, said bracket head mountable to said handlebar, said tubular outer stem of said spotlight assembly fit within said central channel.

14. The mounting arrangement according to claim 13, comprising a first support bracket, said support bracket connected to said bracket head and connectable to said handlebar to elevate said bracket head above said handlebar.

15. The mounting arrangement according to claim 13, wherein said vehicle includes a wind deflector that turns with said handlebar, and further comprising a further support bracket connected to said outer stem between said lamp and said bracket head and connectable to said wind deflector.
